(19) United States
(12) Patent Application Publication
(10) Pub. No.: US 2020/0167764 A1
(43) Pub. Date: May 28, 2020

(54) BLOCKCHAIN-BASED TRANSACTION RECORDATION METHOD AND RELATED PRODUCTS

(71) Applicant: Xiahong Lin, Shanghai (CN)

(72) Inventor: Xiahong Lin, Shanghai (CN)

(21) Appl. No.: 16/228,744

(22) Filed: Dec. 20, 2018

(30) Foreign Application Priority Data
Nov. 26, 2018 (CN) 201811418362.7

(51) Int. Cl. G06Q 20/36; G06Q 20/40; H04L 9/06

(52) U.S. Cl. CPC G06Q 20/3678; H04L 9/0637; G06Q 20/401; G06Q 20/3674

(57) ABSTRACT

The present disclosure provides a blockchain-based transaction recordation method and the related products, wherein the method comprises: packaging transaction data into a to-be-confirmed transaction by a transaction initiator according to a blockchain transaction format, wherein the to-be-confirmed transaction is accompanied by encrypted signature information for confirming payment of a digital currency transaction fee and an exchange rate between the digital currency and a native token; sending the to-be-confirmed transaction to a transaction validator by the transaction initiator; after the transaction validator verifies the to-be-confirmed transaction, the digital currency exchanger deducts the digital currency transaction fee from the transaction initiator and the transaction validator deducts a native token transaction fee from the digital currency exchanger; and recording the to-be-confirmed transaction and finally confirming it by the transaction validator.

### CROSS REFERENCE TO RELATED APPLICATION

The present application claims priority to Chinese patent application No. 201811418362.7, entitled “Blockchain-Based Transaction Recordation Method and Related Products”, filed on Nov. 26, 2018, the entire content of which is incorporated herein by reference.

### TECHNICAL FIELD

The application relates to the technical field of blockchains, and particularly to a blockchain-based transaction recordation method and the related products.

### BACKGROUND

A blockchain is a distributed ledger based on cryptographic security, which is a conveniently-verified and immutable ledger. The blockchain can be decentralized, such as Bitcoin and Ethereum, or it can be centralized, such as Ripple, various private or consortium blockchains, and the like.

A smart contract is a program or script recorded on the blockchain with specific functions, which ensures its uniqueness by using an immutable feature of the blockchain.

An account, that is, a wallet, is a set of combination of numbers generated based on cryptography, which consists of keys and addresses. A user obtains a permission of a corresponding account on the blockchain by using the key. A native token refers to a token needed for normal operation of the blockchain to embody token's governance interests, such as Bitcoin and Ethereum. A digital currency refers to a currency created through secondary development on a blockchain system. It should be noted that the native token is a type of digital currency.

Now, recording transactions require users to have native tokens in their own accounts, and for most ordinary users, their accounts do not necessarily have the native tokens, what is more, recording their transactions cannot be implemented based on other digital currencies, which increases the difficulty of recording the transactions on blockchain.

### SUMMARY

Embodiments of the application provide a blockchain-based transaction recordation method and related products, which implement that a transaction may be recorded through a digital currency without using a native token as a transaction fee, thereby facilitating the promotion of the digital currency, achieving the recordation through the digital currency, and enhancing the user experience.

According to the first embodiment, an embodiment of the application provides a blockchain-based transaction recordation method, which includes the following steps:

packaging transaction data into a to-be-confirmed transaction by a transaction initiator according to a blockchain transaction format, wherein the to-be-confirmed transaction is accompanied by encrypted signature information for confirming payment of a digital currency transaction fee and an exchange rate between the digital currency and a native token;

sending the to-be-confirmed transaction to a transaction validator by the transaction initiator;

after the transaction validator verifies the to-be-confirmed transaction, deducting the digital currency transaction fee from the transaction initiator by a digital currency exchanger, and deducting a native token transaction fee from the digital currency exchanger by a transaction validator; and

recording the to-be-confirmed transaction and finally confirming it by the transaction validator.

Preferably, the transaction data is arbitrary data.

Preferably, before sending the to-be-confirmed transaction to a transaction validator by the transaction initiator, the method further includes:

determining the digital currency exchanger by the transaction initiator.

Preferably, the determining the digital currency exchanger by the transaction initiator specifically includes:

selecting one digital currency exchanger by the transaction initiator as the digital currency exchanger for recording the transaction; or

searching, by the transaction initiator, multiple exchangers that support digital currency exchange, and selecting one exchanger with the lowest exchange rate from the multiple exchangers as the digital currency exchanger for recording the transaction.

Preferably, the verifying the to-be-confirmed transaction by the transaction validator specifically includes:

verifying whether the to-be-confirmed transaction is in a correct format or not by the transaction validator;

determining that the digital currency transaction fee of the transaction initiator is sufficient to pay the to-be-confirmed transaction by the transaction validator;

determining that there is a balance sufficient to transfer the digital currency in an account of the transaction initiator by the transaction validator;

determining that the digital currency exchanger supports automatic exchange between the digital currency and the native token by the transaction validator;

determining that the digital currency exchanger accepts the exchange rate between the digital currency and the native token by the transaction validator, wherein the exchange rate is specified by the transaction initiator; and

determining that there is a sufficient native token balance in an account of the digital currency exchanger by the transaction validator.

According to the second embodiment, a blockchain is provided, the blockchain includes a transaction initiator, a transaction validator and a digital currency exchanger; wherein

the transaction initiator is configured to package transaction data into a to-be-confirmed transaction according to a blockchain transaction format, wherein the to-be-confirmed transaction is accompanied by encrypted signature information for confirming payment of a digital currency transaction fee and an exchange rate between the digital currency and a native token;

the transaction validator is configured to verify the to-be-confirmed transaction;

the digital currency exchanger is configured to deduct the digital currency transaction fee from the transaction initiator; and

the transaction validator is further configured to deduct a native token transaction fee from the digital currency exchanger; and record the to-be-confirmed transaction and finally confirm it.

Preferably, the transaction data is arbitrary data.

Preferably, the transaction initiator is specifically configured to determine the digital currency exchanger.

Preferably, the transaction validator is specifically configured to verify whether the to-be-confirmed transaction is in a correct format or not; determine that the digital currency transaction fee of the transaction initiator is sufficient to pay the to-be-confirmed transaction and that there is a balance sufficient to transfer the digital currency in an account of the transaction initiator; determine that the digital currency exchanger supports automatic exchange between the digital currency and the native token; determine that the digital currency exchanger accepts the exchange rate between the digital currency and the native token, wherein the exchange rate is specified by the transaction initiator; and determine that there is a sufficient native token balance in an account of the digital currency exchanger.

According to the third embodiment, a computer-readable storage medium storing a program for electronic data interchange is provided, wherein the program causes a terminal to perform the method according to the first aspect.

Implementing the embodiments of the application has the following beneficial effects:

It may be seen that, in the blockchain provided by the application, the digital currency exchanger plays a role in exchanging the digital currency into the native token, and the transaction initiator may specify the digital currency owned in an account as a transaction fee for recording the transaction, provided that the digital currency exchanger supports the exchange of the digital currency with the native token. Any digital currency may be used as the transaction fee, so that having the native token is not a prerequisite for the transaction initiator to use the blockchain any more.

### BRIEF DESCRIPTION OF THE DRAWINGS

In order to more clearly illustrate technical solutions in embodiments of the application, accompanying drawings required to be used in the description of the embodiments will be briefly described below. Obviously, the accompanying drawings described below are some embodiments of the application. Those skilled in the art may further obtain other accompanying drawings based on these accompanying drawings without paying any creative work.

FIG. 1 is a schematic flow diagram of blockchain-based transaction recordation method.

FIG. 2 is a schematic flow diagram of a blockchain-based transaction recordation method according to the application.

FIG. 3 is a schematic flow diagram of another blockchain-based transaction recordation method according to the application.

FIG. 4 is a schematic diagram showing a structure of a blockchain according to an embodiment of the application.

### DESCRIPTION OF THE EMBODIMENTS

Technical solutions in embodiments of the application will be clearly and completely described below with reference to accompanying drawings in the embodiments of the application. Obviously, the described embodiments are some, but not all embodiments of the application. All other embodiments obtained by those ordinarily skilled in the art based on the embodiments of the application without any creative work belong to a protective scope of the application.

A and B of the application are merely references but are different in denotations without actual meanings. The references, for example, “S101” and “S102”, of steps in the application do not represent a logical order of performing the steps.

In a current blockchain, a user needs to pay a transaction fee when initiating transaction recordation and must use a native token specified by the blockchain. The transaction recordation refers to uploading a transaction (that is, a certain amount of data) to a public blockchain.

For example, by taking the transaction recordation with a digital currency transfer as an example, a digital currency serves as a cinema bonus point, and for this bonus point, a user A transfers 1000 bonus points to a user B. If the user A needs to transfer on the blockchain, the user A needs to pay a certain amount of Bitcoin (BTC) as a transaction fee (for example, 1 Satoshi); and for another example, for an Ethereum blockchain, when the user A initiates a transaction to the user B, the user A needs to pay a certain amount of Ethereum (ETH) as a transaction fee. Each time the user A needs to initiate a transfer transaction on the blockchain, he or she must have a native token in an account. While the blockchain may be used to issue any digital currency, for example, there are hundreds of digital currencies issued on Ethereum and EOS currently, these third-party digital currencies issued on the blockchain may not be used to pay the transaction fee for the blockchain. Meanwhile, each time the user issues and sends these third-party digital currencies, he or she needs to pay the native token as the transaction fee.

The application proposes a blockchain-based digital currency automatic exchange mechanism, which enables the user to use any digital currency owned in the account to pay the transaction fee without having the native token in advance, as such, the transaction recordation is actually conveniently implemented on the blockchain, the digital currency of the entire blockchain is activated and the transaction recordation is simplified.

The following describes the principle of the blockchain. The blockchain basis actually refers to a data link, in the blockchain, anyone may upload data in the blockchain, but such data uploading requires a certain cost, which is implemented by adopting the native token. A reason for using the native token is to avoid data explosion in the blockchain. By taking Bitcoin as an example, mining machines and electric charges must be invested in the current acquisition of the Bitcoin. In this case, the Bitcoin may not be obtained for free. At present, an exchange rate between Bitcoin and US dollars is around 1 to 5000. Therefore, if the user A wants to upload a piece of data in the blockchain, he or she needs to pay some Bitcoin as a cost according to the size of the data. Here is why paying in digital currency (also called a secondary token) is not supported. Because anyone can create arbitrarily a digital currency at almost no cost. If a recordation operation may be implemented by paying the digital currency, the user may perform the recordation operation at no cost, which inevitably causes the entire blockchain to burst and affects the promotion and use of the blockchain, so that regardless of any blockchain, the recordation must be at the expense of using the native token.

The blockchain in the application is composed of one or more nodes, which may specifically be a smart device, and the smart device may specifically include a smartphone, a computer, a server, and the like. Certainly, in actual applications, the smart device needs to support the blockchain, that is, needs to support a software protocol of the blockchain. The application does not limit the content and the manifestation form of the specific software protocol.

The transaction initiator, the transaction validator and the data currency exchanger in the application all complete the steps described in the application through a blockchain node established by itself or a blockchain node established according to a third party.

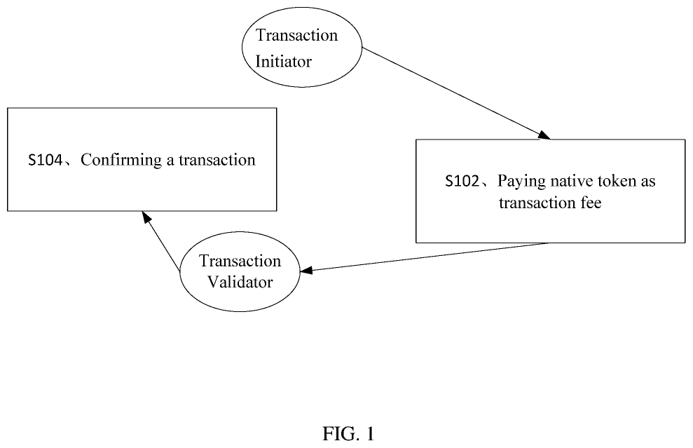

With reference to FIG. 1, FIG. 1 provides a blockchain-based transaction recordation method, which may be performed on a blockchain. As shown in FIG. 1, the method includes the following steps:

step S101: packaging transaction data into a to-be-confirmed transaction by a transaction initiator according to a blockchain transaction format, and accompanied by encrypted signature information for confirming payment of a native token transaction fee;

step S102: sending the to-be-confirmed transaction to a transaction validator by the transaction initiator in a direct or indirect manner;

step S103: performing a series of verifications by the transaction validator, including but not limited to: verifying whether the to-be-confirmed transaction is in a correct format or not, whether the native token transaction fee specified by the transaction initiator is sufficient to pay the to-be-confirmed transaction or not, and whether there is a sufficient native token balance in an account of the transaction initiator or not; and

step S104: deducting the native token transaction fee from the account of the transaction initiator by the transaction validator, transferring the native token transaction fee into an account of the transaction validator by the transaction validator, and recording the to-be-confirmed transaction on the blockchain and finally confirming it by the transaction validator.

It may be known from a flow as shown in FIG. 1 that the account of the transaction initiator for recording the transaction in a current blockchain needs sufficient native tokens, which is impossible for most users. For example, a user A is a member of a cinema chain, which needs to transfer his or her bonus points (a type of digital currency) to an account of a user B. If the user A does not have corresponding native tokens, the user A further needs to exchange or purchase the native tokens, which inevitably makes it not initiate the transfer of the digital currency, affecting the use of the digital currency.

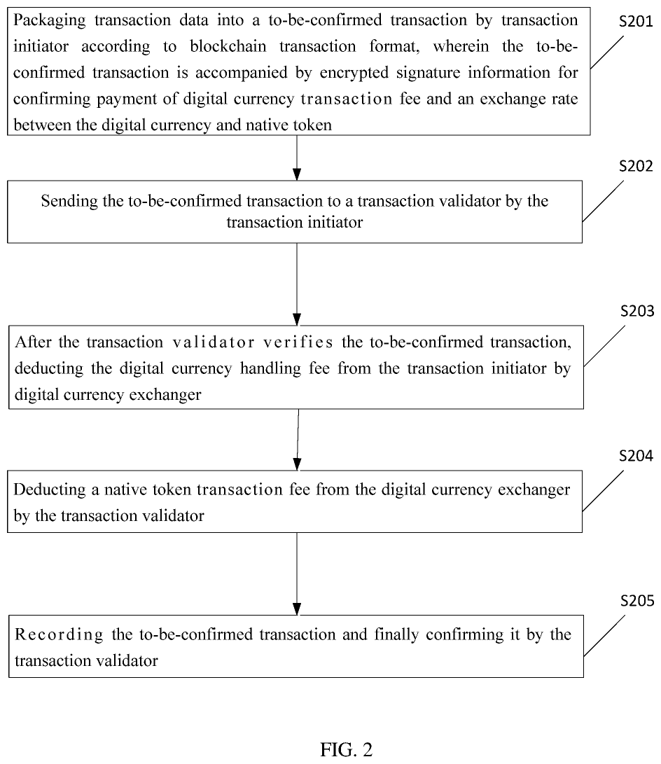

With reference to FIG. 2, FIG. 2 is a blockchain-based transaction recordation method of the application. The method may be performed on the blockchain. As shown in FIG. 2, the method includes the following steps:

step S201: packaging transaction data into a to-be-confirmed transaction by a transaction initiator according to a blockchain transaction format, wherein the to-be-confirmed transaction is accompanied by encrypted signature information for confirming payment of a digital currency transaction fee and an exchange rate between the digital currency and a native token.

In particular, the transaction data may be further accompanied by a digital currency exchanger. Certainly, in actual applications, the digital currency exchanger may be determined by the blockchain through automatically search.

step S202: sending the to-be-confirmed transaction to a transaction validator by the transaction initiator;

step S203: after the transaction validator verifies the to-be-confirmed transaction, deducting the digital currency transaction fee from the transaction initiator by a digital currency exchanger,

step S204: deducting a native token transaction fee from the digital currency exchanger by the transaction validator; and

step S205: recording the to-be-confirmed transaction and finally confirming it by the transaction validator.

Preferably, the transaction data is arbitrary data, such as pictures, digital currencies, and financial currencies.

The digital currency in the digital currency transaction fee may be any type of digital currency, provided that the digital currency is not a native token.

In particular, the step of verifying the to-be-confirmed transaction by the transaction validator specifically includes:

verifying whether the to-be-confirmed transaction is in a correct format or not by the transaction validator;

determining that the digital currency transaction fee of the transaction initiator is sufficient to pay the to-be-confirmed transaction by the transaction validator;

determining that there is a sufficient balance of the digital currency transaction fee in an account of the transaction initiator by the transaction validator;

determining that the digital currency exchanger supports automatic exchange between the digital currency and the native token by the transaction validator;

determining that the digital currency exchanger accepts the exchange rate between the digital currency and the native token by the transaction validator, wherein the exchange rate is specified by the transaction initiator; and

determining that there is a sufficient native token balance in an account of the digital currency exchanger by the transaction validator.

In the blockchain provided by the application, the digital currency exchanger plays a role in exchanging the digital currency into the native token, and the transaction initiator may specify the digital currency owned in the account as a transaction fee for recording the transaction, provided that the digital currency exchanger supports the exchange of the digital currency with the native token. Any digital currency may be used as the transaction fee, so that having the native token is not a prerequisite for the transaction initiator to use the blockchain any more.

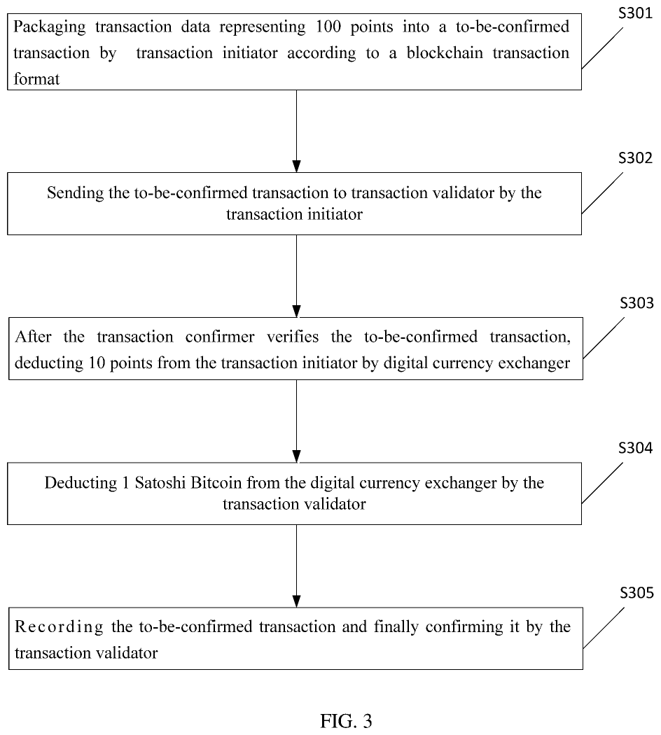

The following is a practical example to illustrate the above-mentioned transaction recordation method. The above transaction recordation is based on a bonus point transfer as an example. The above-mentioned native token is based on Bitcoin as an example. With reference to FIG. 3, FIG. 3 provides a blockchain-based digital currency transfer method. As shown in FIG. 3, the method includes the following steps:

step S301: packaging transaction data representing 100 bonus point into a to-be-confirmed transaction by a transaction initiator according to a blockchain transaction format, wherein the to-be-confirmed transaction is accompanied by encrypted signature information for confirming payment of 10 points as a digital currency transaction fee and an exchange rate (1 Satoshi to 10 points) between the digital currency and a native token;

step S302: sending the to-be-confirmed transaction to a transaction validator by the transaction initiator;

step S303: after the transaction validator verifies the to-be-confirmed transaction, deducting 10 points from the transaction initiator by a digital currency exchanger;

step S304: deducting 1 Satoshi Bitcoin from the digital currency exchanger by the transaction validator; and

step S305: recording the to-be-confirmed transaction and finally confirming it by the transaction validator, and deducting 100 points from the transaction initiator by a transaction recipient.

The transaction initiator in the technical solution provided by the application pays 110 points and successfully transfers the 100 points to the account of the transaction recipient through the digital currency exchanger, and successfully records the transaction, thereby achieving that the transaction initiator transfers the digital currency in the blockchain without paying the native token, and improving the convenience of circulation of the digital currency.

In particular, the digital currency exchanger may be manually determined by the transaction initiator. Certainly, in actual applications, the digital currency exchanger may further be automatically determined by the transaction initiator, for example, the transaction initiator determines the digital currency A used by the transaction fee, searches the digital currency exchanger that supports the exchange of the digital currency A in the blockchain, and if there are a plurality of digital currency exchangers, selects one digital currency exchanger with the lowest exchange rate from the plurality of digital currency exchangers as the digital currency exchanger for recording the transaction.

In the blockchain described in this application, any user may become the digital currency exchanger, with specific steps as follows:

depositing a certain amount of native tokens in an account or smart contract by the user according to a specified format;

specifying the exchange of one or more digital currencies in the account or smart contract by the user according to the specified format;

specifying an exchange rate between the supported digital currency and the native tokens in the account or smart contract by the user according to the specified format; and

indicating that the account of the user may become the digital currency exchanger.

It should be noted that, in the blockchain described in the application, the blockchain transaction that occurs in the above steps may be completed by using a digital currency that has been automatically exchangeable by the exchanger as a transaction fee as well.

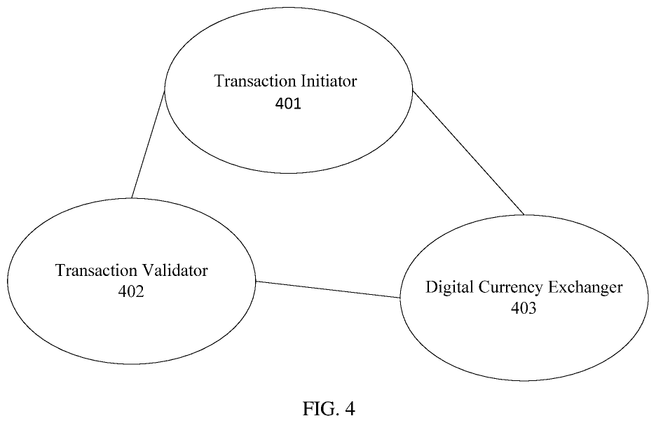

With reference to FIG. 4, FIG. 4 provides a blockchain, which is characterized by including a transaction initiator 401, a transaction validator 402 and a digital currency exchanger 403; wherein

the transaction initiator is configured to package transaction data into a to-be-confirmed transaction according to a blockchain transaction format, wherein the to-be-confirmed transaction is accompanied by encrypted signature information for confirming payment of a digital currency transaction fee and an exchange rate between the digital currency and a native token; send the to-be-confirmed transaction to the transaction validator;

the transaction validator is configured to verify the to-be-confirmed transaction;

the digital currency exchanger is configured to deduct the digital currency transaction fee from the transaction initiator; and

the transaction validator is further configured to deduct a native token transaction fee from the digital currency exchanger; and record the to-be-confirmed transaction and finally confirm it.

In a blockchain provided by the application, the digital currency exchanger plays a role in exchanging digital currency into the native token, and the transaction initiator may specify the digital currency owned in an account as a transaction fee for recording the transaction, provided that the digital currency exchanger supports the exchange of the digital currency with the native token. Any digital currency may be used as the transaction fee, so that having the native token is not a prerequisite for the transaction initiator to use the blockchain any more.

One embodiment of the application further provides a computer-readable storage medium storing a program for electronic data interchange, wherein the program causes a terminal to perform some or all of steps of any one of the blockchain-based transaction recordation methods as recited in the foregoing method embodiments.

Another embodiment of the application further provides a computer program product, including a non-transitory computer-readable storage medium storing a computer program, wherein the computer program is operative to cause a computer to perform some or all of steps of any one of the blockchain-based transaction recordation methods as recited in the foregoing method embodiments.

It should be noted that, for the foregoing method embodiments, for the sake of brevity, they are all described as a series of action combinations, but those skilled in the art should understand that the application is not limited by an order of the described actions as certain steps may be performed in other orders or concurrently in accordance with the application. In addition, those skilled in the art should also understand that the embodiments described in the specification are optional embodiments, and actions and modules involved are not necessarily required by the application.

In the above embodiments, there is a different emphasis placed on the description of each embodiment, and parts that are not detailed in a certain embodiment may refer to related descriptions of other embodiments.

A technical solution of the application may be stored in a computer-readable memory if it is implemented in a form of a software program module and sold or used as a stand-alone product. Based on such an understanding, the technical solution of the application in essence, or a portion thereof making a contribution to the prior art, or all or a portion of the technical solution may be embodied in a form of a software product, and the computer software product is stored in a memory, and includes a number of instructions to cause a computer device (which may be a personal computer, a server or a network device) to perform all or a portion of steps of the method described in each embodiment of the application. The foregoing memory includes various media, such as a U disk, a Read-Only Memory (ROM), a Random Access Memory (RAM), a portable hard disk, a magnetic disk, or an optical disk, which may store program codes.

Those ordinarily skilled in the art may understand that all or a portion of steps in various methods of the above embodiments may be completed by a program to instruct related hardware, the program may be stored in a computer-readable memory, and the memory may include a flash drive, a read-only memory (abbreviated ROM), a random access memory (abbreviated RAM), a disk or a CD.

The embodiments of the application have been described in detail above. The principle and implementations of the application have been described herein by applying specific examples. The above embodiments are described for helping understand the methods and core ideas of the application. Those ordinarily skilled in the art will have changes in the detailed description and the application scope according to the idea of the application. In summary, the content of the specification should not be construed as limiting the application.

What is claimed is:

1. A blockchain-based transaction recordation method, comprising the following steps:
packaging transaction data into a to-be-confirmed transaction by a transaction initiator according to a blockchain transaction format, wherein the to-be-confirmed transaction is accompanied by encrypted signature information for confirming payment of a digital currency transaction fee and an exchange rate between the digital currency and a native token;
sending the to-be-confirmed transaction to a transaction validator by the transaction initiator;
after the transaction validator verifies the to-be-confirmed transaction, deducting the digital currency transaction fee from the transaction initiator by the digital currency exchanger, and deducting a native token transaction fee from the digital currency exchanger by the transaction validator; and
recording the to-be-confirmed transaction and confirming it by the transaction validator.

2. The method of claim 1, wherein the transaction data is arbitrary data.

3. The method of claim 1, wherein before sending the to-be-confirmed transaction to a transaction validator by the transaction initiator, further comprising:
determining the digital currency exchanger by the transaction initiator.

4. The method of claim 3, wherein determining the digital currency exchanger by the transaction initiator specifically comprises:
selecting one digital currency exchanger by the transaction initiator as the digital currency exchanger for recording the transaction; or
searching, by the transaction initiator, multiple exchangers that support digital currency exchange, and selecting one exchanger with a lowest exchange rate from the multiple exchangers as the digital currency exchanger for recording the transaction.

5. The method of claim 1, wherein the verifying the to-be-confirmed transaction by the transaction validator specifically comprises:
verifying whether the to-be-confirmed transaction is in a correct format or not by the transaction validator;
determining that the digital currency transaction fee of the transaction initiator is sufficient to pay the to-be-confirmed transaction by the transaction validator;
determining that there is a balance sufficient to transfer the digital currency in an account of the transaction initiator by the transaction validator;
determining that the digital currency exchanger supports automatic exchange between the digital currency and the native token by the transaction validator;
determining that the digital currency exchanger accepts the exchange rate between the digital currency and the native token by the transaction validator, wherein the exchange rate is specified by the transaction initiator; and
determining that there is a sufficient native token balance in an account of the digital currency exchanger by the transaction validator.

6. A blockchain comprising a transaction initiator, a transaction validator and a digital currency exchanger; wherein
the transaction initiator is configured to package transaction data into a to-be-confirmed transaction according to a blockchain transaction format, wherein the to-be-confirmed transaction is accompanied by encrypted signature information for confirming payment of a digital currency transaction fee and an exchange rate between the digital currency and a native token; and send the to-be-confirmed transaction to a transaction validator;
the transaction validator is configured to verify the to-be-confirmed transaction;
the digital currency exchanger is configured to deduct the digital currency transaction fee from the transaction initiator; and
the transaction validator is further configured to deduct a native token transaction fee from the digital currency exchanger; and record the to-be-confirmed transaction and finally confirm it.

7. The blockchain of claim 6, wherein the transaction data is arbitrary data.

8. The blockchain of claim 6, wherein the transaction initiator is configured to determine the digital currency exchanger.

9. The blockchain of claim 8, wherein
the transaction validator is configured to verify whether the to-be-confirmed transaction is in a correct format or not; determine that the digital currency transaction fee of the transaction initiator is sufficient to pay the to-be-confirmed transaction and that there is a balance sufficient to transfer the digital currency in an account of the transaction initiator; determine that the digital currency exchanger supports automatic exchange between the digital currency and the native token; determine that the digital currency exchanger accepts the exchange rate between the digital currency and the native token, wherein the exchange rate is specified by the transaction initiator; and determine that there is a sufficient native token balance in an account of the digital currency exchanger.

10. A computer-readable storage medium for storing a program for electronic data interchange, wherein the program causes a terminal to perform the method of claim 1.
